(19) United States
(12) Patent Application Publication
(10) Pub. No.: US 2017/0317642 A1
(43) Pub. Date: Nov. 2, 2017

(54) Photovoltaic Concentrator for Spacecraft Power Comprising an Ultra-Light Graphene Radiator for Waste Heat Dissipation

(71) Applicant: Mark J. O'Neill, Keller, TX (US)

(72) Inventor: Mark J. O'Neill, Keller, TX (US)

(21) Appl. No.: 15/141,162

(22) Filed: Apr. 28, 2016

(51) Int. Cl. H02S 40/22; H02S 40/42; H02S 20/32

(52) U.S. Cl. CPC H02S 40/22; H02S 20/32; H02S 40/42

(57) ABSTRACT

This invention includes an optical concentrator which focuses incident sunlight onto a photovoltaic cell or group of photovoltaic cells which is mounted in thermal contact with a radiator comprising ultra-light graphene sheet. In the preferred embodiment, the optical concentrator comprises a thin Fresnel lens, the photovoltaic cell or group of photovoltaic cells comprises a high-efficiency multi junction device, and the graphene radiator comprises a very thin and light sheet. In the preferred embodiment, the graphene radiator is deployed and supported in space as a stressed membrane by employing tension in one or more directions.

### CROSS REFERENCE TO RELATED APPLICATION

The present non-provisional application for patent was previously submitted to the U.S. Patent and Trademark Office as a provisional application, Application No. 62/162041, Attorney Docket No. Mjo-2015-P-001, filed on May 15, 2015, with Confirmation No. 2657. The title, inventor, and disclosed invention were the same for the earlier provisional application as for this present non-provisional application. The inventor hereby claims the filing date of the earlier provisional application, namely May 15, 2015.

### BACKGROUND

The present inventor has previously invented other photovoltaic concentrators for providing spacecraft power, including U.S. Pat. Nos. 5,344,497, 5,505,789, 6,031,179, 6,075,200, and 6,111,190, as well as several pending applications. NASA and the U.S. Department of Defense have recognized the many advantages of these space photovoltaic concentrator inventions, flying one version on the PASP+ flight experiment in 1994-95, using another version to power the solar electric ion-thruster and the spacecraft on the Deep Space 1 mission to an asteroid and a comet in 1998-2001, flying an improved version flight experiment on the TacSat 4 spacecraft launched in 2011, and funding development of next-generation versions under several on-going contracts. A recent presentation by the inventor at the Space Photovoltaic Research and Technology (SPRAT) conference at NASA Glenn Research Center in October 2014 provides full background and then-present status of these many development programs over the past 20 years to advance space photovoltaic concentrator technology (Reference 1).

Other researchers have also developed different types of photovoltaic concentrators for spacecraft power. For all of these approaches, the basic advantage of concentrators is to reduce the amount of expensive photovoltaic cell area and relatively heavy mass related to such cell packages by focusing sunlight onto smaller cells by using optical devices such as Fresnel lenses. Space photovoltaic concentrators thereby offer dramatic improvements in all of the critical performance metrics for space solar arrays, including lower cost ($/Watt of array power output), higher specific power (Watts/kilogram of array mass), higher stowed power (Watts/cubic meter of launch volume), improved photovoltaic cell radiation hardness (due to smaller cell sizes, allowing thicker radiation shielding at lower mass penalty), and higher voltage operation (again due to the smaller cell sizes, allowing thicker dielectric insulation at lower mass penalty.

Since photovoltaic cells only convert a portion of the focused sunlight into electricity, the remainder must be dissipated as waste heat to deep space. Even a cell that converts 40% of the focused sunlight into electricity will have the remaining 60% of the focused sunlight converted to heat. To dissipate this waste heat to deep space, this heat must be conducted over a radiator much larger in area than the cell, and then this waste heat is radiated to deep space which is very cold. Without such a radiator, the cell would overheat and the solar array would fail. By using a large radiator with high thermal conductivity to spread the heat over its surface, and high emissivity to efficiently radiate the heat to deep space over its surface, the cell is maintained at a modest temperature and the power production is outstanding. The radiator must be thin to have a low mass, since mass is the most critical parameter for a space solar array. In the past, the best radiator material has been carbon-fiber reinforced composite sheet. The second-best radiator material has been aluminum sheet, with a coating to enhance its emissivity. Recently, the new field of nanotechnology has led to development of extraordinary new materials, including carbon nanotubes and graphene sheet. The present invention is a space photovoltaic concentrator system comprising one or more optical concentrators, one or more photovoltaic cells, and one or more ultra-light graphene sheet radiators, typically only about 25 microns thick and weighing less than 60 grams per square meter of area. As shown in the table below, the new radiator provides 5× better thermal performance per unit mass than a carbon-fiber reinforced composite sheet and 10× better thermal performance per unit mass than an aluminum sheet. This new invention therefore enables a breakthrough in terms of performance metrics and mass metrics for photovoltaic concentrators for spacecraft power.

| | Effective | | | |
|---|---|---|---|---|
| | Thermal | | Tensile | |
| | Conductivity, k | Density, ρ | Strength | k/ρ |
| Material | (W/m-K) | (kg/m³) | (MPa) | (W-m²/kg-K) |
| Carbon Fiber | 240 | 1,750 | 1,500 | 0.14 |
| Composite Sheet | | | | |
| Aluminum Sheet | 200 | 2,700 | 200 | 0.07 |
| Graphene Sheet | 1,600 | 2,200 | 150 | 0.73 |

### BRIEF SUMMARY OF THE INVENTION

This invention includes an optical concentrator which focuses sunlight onto a photovoltaic cell or interconnected group of photovoltaic cells. The aperture area of the lens is larger than the area of the photovoltaic cell, thereby achieving savings in the cost and mass of the photovoltaic cell compared to one-sun planar arrays without an optical concentrator. The solar cell is mounted in intimate thermal contact to a heat-spreading radiator which dissipates the waste heat from the photovoltaic cell by conducting this heat over a larger area than the photovoltaic cell and then radiating this heat to deep space over the full radiator area. A key feature of the new invention is the radiator, which comprises an ultra-light graphene sheet.

### BRIEF DESCRIPTION OF THE DRAWINGS

FIG. 1 presents a perspective view of the preferred embodiment of the new invention. FIG. 1 shows a perspective view of the optical concentrator, comprising a line-focus Fresnel lens in this embodiment, focusing sunlight onto a photovoltaic cell, which is mounted to a thin graphene radiator, which dissipates the waste heat from the photovoltaic cell.

FIG. 2 presents a perspective view of a second preferred embodiment of the new invention. FIG. 1 shows a perspective view of the optical concentrator, comprising a point-focus Fresnel lens in this embodiment, focusing sunlight onto a photovoltaic cell, which is mounted to a thin graphene radiator, which dissipates the waste heat from the photovoltaic cell.

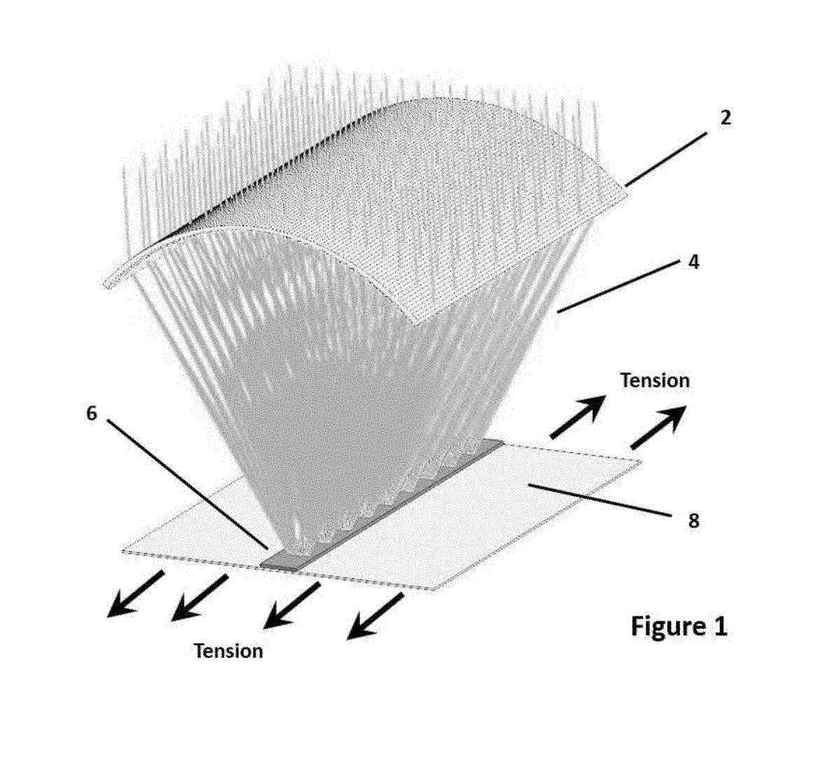

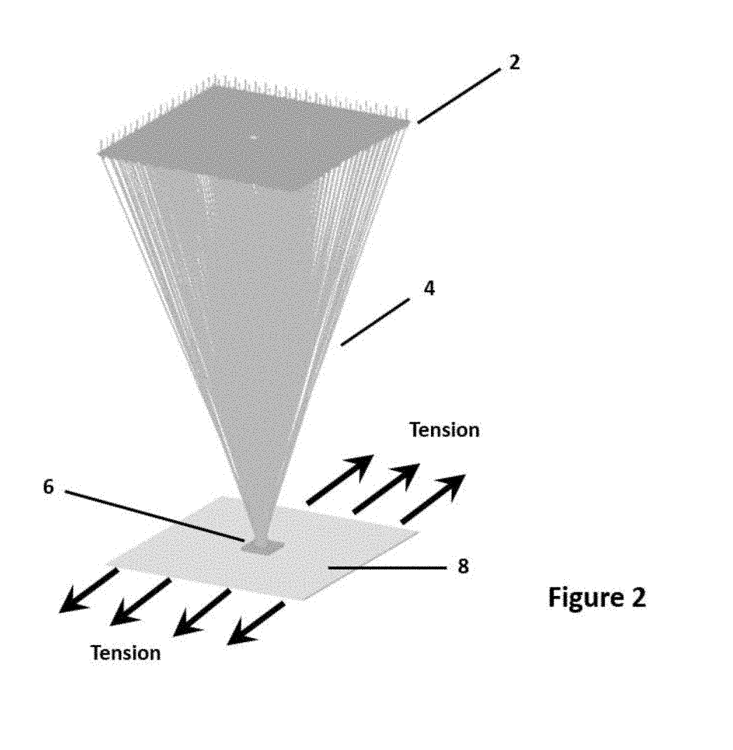

In actual practice, as one of ordinary skill in the art would readily understand, multiple lenses and multiple photovoltaic cells would be integrated into a larger solar array, but FIG. 1 shows the basic building block of a larger array comprising line-focus Fresnel lenses, photovoltaic cells, and graphene radiators. Similarly, FIG. 2 shows the basic building block of a larger array comprising point-focus Fresnel lenses, photovoltaic cells, and graphene radiators.

### DETAILED DESCRIPTION AND BEST MODE OF IMPLEMENTATION

The present invention is best understood by referring to the attached drawings, which show a preferred embodiment and an alternate preferred embodiment. Referring to FIG. 1, the optical concentrator is a line-focus Fresnel lens comprising a thin transparent flexible polymeric Fresnel lens 2 which includes a plurality of small prisms configured to refractive incident sunlight into a focal region where a photovoltaic cell or group of photovoltaic cells 6 is located to convert the concentrated sunlight into electricity. The polymeric lens 2 and the graphene radiator 6 are mechanically integrated with a deployment and support structure such as taught by Spence in U.S. Pat. No. 8,636,253. The position of the lens 2 and the position of the photovoltaic cell or group of photovoltaic cells 6 are maintained by the deployment and support structure in their proper relative locations so that the lens 2 focuses incident sunlight shown by rays 4 onto the photovoltaic cell or group of photovoltaic cells 6. The photovoltaic cell or group of photovoltaic cells 6 is mounted to a graphene radiator 8 which dissipates waste heat from the photovoltaic cell or group of photovoltaic cells 6 to maintain the photovoltaic cell or group of photovoltaic cells 6 at a reasonable temperature for high solar-to-electrical conversion efficiency.

For proper performance in space, the preferred embodiment of the photovoltaic concentrator shown in FIG. 1 would be deployed and supported on orbit with an appropriate solar array structure and sun-tracking system. The preferred approach to such deployment and support is a stretched blanket approach such as taught by Spence in U.S. Pat. No. 8,636,253, in which the lenses are tensioned from the ends of the deployment structure and the radiators are tensioned from the ends of the deployment structure. The lenses form one blanket while the radiators with photovoltaic cells form a second parallel blanket. Both blankets are supported as stressed membranes with tension keeping these blankets in the proper shape and position relative to one another. The entire array rotates to follow the sun about either one or two axes. The tensioning of an individual piece of graphene radiator is shown in FIG. 1.

Referring to FIG. 2, the optical concentrator is a point-focus Fresnel lens comprising a thin transparent flexible polymeric Fresnel lens 2 which includes a plurality of small prisms configured to refractive incident sunlight into a focal region where a photovoltaic cell or group of photovoltaic cells 6 is located to convert the concentrated sunlight into electricity. The polymeric lens 2 and the graphene radiator 6 are mechanically integrated with a deployment and support structure such as taught by Spence in U.S. Pat. No. 8,636,253. The position of the lens 2 and the position of the photovoltaic cell or group of photovoltaic cells 6 are maintained by the deployment and support structure in their proper relative locations so that the lens 2 focuses incident sunlight shown by rays 4 onto the photovoltaic cell or group of photovoltaic cells 6. The photovoltaic cell or group of photovoltaic cells 6 is mounted to a graphene radiator 8 which dissipates waste heat from the photovoltaic cell or group of photovoltaic cells 6 to maintain the photovoltaic cell or group of photovoltaic cells 6 at a reasonable temperature for high solar-to-electrical conversion efficiency.

For proper performance in space, the preferred embodiment of the photovoltaic concentrator shown in FIG. 2 would be deployed and supported on orbit with an appropriate solar array structure and sun-tracking system. The preferred approach to such deployment and support is a stretched blanket approach such as taught by Spence in U.S. Pat. No. 8,636,253, in which the lenses are tensioned from the ends of the deployment structure and the radiators are tensioned from the ends of the deployment structure. The lenses form one blanket while the radiators with photovoltaic cells form a second parallel blanket. Both blankets are supported as stressed membranes with tension keeping these blankets in the proper shape and position relative to one another. The entire array rotates to follow the sun about either one or two axes. The tensioning of an individual piece of graphene radiation is shown in FIG. 2.

For the preferred embodiment shown in FIG. 1 or the alternate embodiment shown in FIG. 2, the polymeric lens 2 can be made from a space-qualified silicone rubber such as Dow Corning DC 93-500 material, with a total thickness of about 100-200 microns. The lens 2 can also include strengthening elements such as a transparent glass or polymer film superstrate, or embedded glass or metal mesh. Such lenses are fully described in Reference 1. For space applications, the lens should be coated on its outside surface with an ultraviolet rejection (UVR) coating which blocks the vacuum ultraviolet (VUV) wavelengths below 200 nm, since these wavelengths can darken the silicone lens material as described in Reference 1.

The photovoltaic cell or group of photovoltaic cells 6 can comprise one or more high-efficiency multi junction solar cells, such as the three junction devices presently being made by Spectrolab, a California-based unit of Boeing Company, or SolAero, a company in New Mexico, or several other companies in the world. Many companies are working on four-junction and six junction solar cells for the future, using a configuration called inverted metamorphic (IMM), and these cells would be ideally suited for use in the photovoltaic cell or group of photovoltaic cells 6 when they become available. The photovoltaic cell or group of photovoltaic cells 6 can be interconnected in series using welded silver interconnects or other electrical conductors, and bonded to the radiator with thermally conductive silicone with alumina loading. A dielectric film such as polyimide can be included in the adhesive layer to provide better electrical insulation between the photovoltaic cell or group of photovoltaic cells 6 and the graphene radiator 8. The top of the photovoltaic cell or group of photovoltaic cells 6 can be protected and insulated with a thin ceria-doped glass cover, of typically 100 microns to 500 microns thickness, depending on the radiation exposure of the space mission. The cover glass is typically bonded to the photovoltaic cell or group of photovoltaic cells 6 using clear silicone adhesive such as Dow Corning DC 93-500, the same material used to make the lens 2. A bypass diode is typically added to protect each cell from reverse bias voltage damage which could occur due to shadowing or cell cracking. Persons of ordinary skill in the art will be familiar with the construction and manufacture of the photovoltaic cell or group of photovoltaic cells 6.

The size of the lens 2 is typically selected based on thermal considerations, specifically the thickness and mass of the graphene radiator 8. If the lens aperture width is small, for example 5 cm to 10 cm, the thickness and mass of the radiator 8 can be small while the radiator 8 still provides excellent thermal performance in rejecting waste heat from the photovoltaic cell or group of photovoltaic cells 6. For a small aperture lens 2, the radiator 8 can be made of 25 micron graphene sheet as made by Angstron Materials among other vendors.

The Fresnel lens 2, which comprises a refractive optical element, would perform best if its prismatic pattern includes color-mixing features as taught in U.S. Pat. No. 6,031,179. The lens assembly could be deployed in a flat form as opposed to an arched form, and still clearly fall within the scope of this present invention. Similarly, a mirror concentrator could be used instead of a Fresnel lens concentrator, and still fall within the scope of this present invention. For a mirror concentrator, the radiator would need to be rotated to allow incoming sunlight to hit the mirror before being focused onto the photovoltaic cell or group of photovoltaic cells.

The new invention, including the embodiment shown in FIGS. 1 and 2, and many other embodiments which can be conceived by those of ordinary skill in the art, offers many advantages over other space solar photovoltaic arrays. The new invention provides unprecedented performance and cost advantages in all of the critical performance metrics for space solar arrays, including lower cost ($/Watt of array power output), higher specific power (Watts/kilogram of array mass), higher stowed power (Watts/cubic meter of launch volume), improved photovoltaic cell radiation hardness (due to smaller cell sizes, allowing thicker radiation shielding at lower mass penalty), and higher voltage operation (again due to the smaller cell sizes, allowing thicker dielectric insulation at lower mass penalty). The small size of the photovoltaic cells reduces the area, mass, and cost of these expensive devices compared to other space solar arrays, including planar one-sun arrays and other concentrator arrays which typically operate at lower concentration ratio and lower optical efficiency, such as the ATK CellSaver® array which provides about 1.8× concentration, while the arched lens of FIG. 1 typically provides about 5-10× concentration. As highlighted in Reference 1, Fresnel lens concentrators with multi-junction photovoltaic cells offer spectacular performance for many space missions, especially those requiring high power, high voltage, and high radiation hardness. Solar electric propulsion (SEP) is one such application.

One of ordinary skill in the art of space solar concentrators will fully understand that the graphene radiator 8 in FIGS. 1 and 2 may require coatings to perform well in space, such as a coating to enhance the thermal radiation emittance of the upper and lower surfaces of the radiator and/or a coating to provide protection from the space environment, which may include ultraviolet radiation and monatomic oxygen. One of ordinary skill in the art of space solar concentrators will fully understand that the stretching of the graphene radiator 8 in FIGS. 1 and 2 for deployment and support on orbit may require strengthening of the thin graphene radiator 8. Such strengthening can be accomplished by bonding wires or mesh to the graphene sheet or by integrating another layer of stronger material such as a polymer film to form a laminate with the graphene sheet for the graphene radiator 8 in FIGS. 1 and 2. The key element of the present invention is the heat-spreading graphene material in the radiator 8, and any additional coatings, strengthening elements, or co-laminated materials are just enhancements to the key graphene element, and therefore fall within the scope and spirit of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### REFERENCE (INCORPORATED HEREIN BY REFERENCE)

1. Mark O'Neill, A. J. McDanal, Henry Brandhorst, Kevin Schmid, Peter LaCorte, Michael Piszczor, and Matt Myers, “Development of More Robust Stretched Lens Array (SLA) Technology with Improved Performance Metrics and Significantly Expanded Applications, 23^{rd} NASA Space Photovoltaic Research and Technology Conference (SPRAT XXIII), Cleveland, Ohio, Oct. 29, 2014

I claim:

1. A photovoltaic concentrator comprising at least one optical element for producing a focus of concentrated sunlight onto at least one photovoltaic cell mounted in thermal contact with at least one radiator at least partially comprising graphene.

2. The photovoltaic concentrator of claim 1, wherein the optical element is a line-focus Fresnel lens.

3. The photovoltaic concentrator of claim 1, wherein the optical element is a point-focus Fresnel lens.

4. The photovoltaic concentrator of claim 1, wherein the photovoltaic cell is a multi-junction photovoltaic device.

5. The photovoltaic concentrator of claim 1, wherein the radiator comprises graphene less than 50 microns thick.

6. A waste heat rejection radiator for a space photovoltaic concentrator, said concentrator comprising at least one optical element for producing a focus of concentrated sunlight onto at least one photovoltaic cell mounted in thermal contact with said waste heat radiator, said waste heat radiator at least partially comprising graphene.

7. The waste heat rejection radiator of claim 6, wherein said optical element is a line-focus Fresnel lens.

8. The waste heat rejection radiator of claim 6, wherein said optical element is a point-focus Fresnel lens.

9. The waste heat rejection radiator of claim 6, wherein said photovoltaic cell is a multi junction photovoltaic device.

10. The waste heat rejection radiator of claim 6, wherein said radiator comprises graphene less than 50 microns thick.

11. A waste heat rejection radiator for a space photovoltaic concentrator, said concentrator comprising at least one optical element for producing a focus of concentrated sunlight onto at least one photovoltaic cell mounted in thermal contact with said waste heat radiator, said waste heat radiator at least partially comprising graphene supported as a thin stressed membrane by tension from two or more of its edges.

12. The waste heat rejection radiator of claim 11, wherein said optical element is a line-focus Fresnel lens.

13. The waste heat rejection radiator of claim 11, wherein said optical element is a point-focus Fresnel lens.

14. The waste heat rejection radiator of claim 11, wherein said photovoltaic cell is a multi junction photovoltaic device.

15. The waste heat rejection radiator of claim 11, wherein said radiator comprises graphene less than 50 microns thick.
